(19) United States
(12) Patent Application Publication
(10) Pub. No.: US 2007/0008437 A1
(43) Pub. Date: Jan. 11, 2007

(54) Television tuner having an improved frequency characteristic of a receiver signal

(75) Inventor: Akira Kawamura, Fukushima-ken (JP)

Correspondence Address: BEYER WEAVER & THOMAS, LLP, P.O. BOX 70250, OAKLAND, CA, 94612-0250, US

(73) Assignee: ALPS ELECTRIC CO., LTD.

(21) Appl. No.: 11/430,485

(22) Filed: May 8, 2006

(30) Foreign Application Priority Data
Jul. 7, 2005 (JP) UM 2005-005296

(51) Int. Cl. H04N 5/44

(52) U.S. Cl. 348/736

(57) ABSTRACT

There is provided a television tuner for improving a frequency characteristic of a receiver signal after a FM trap and enhancing a picture quality.

There is provided a television tuner comprising a detour unit 15 that allows a receiver signal directly to pass; a first trap unit 14 that attenuates a predetermined signal band included in the receiver signal; a first switch unit 13 that switches a signal pathway in which the receiver signal passes to any one of the first trap unit and the detour unit; an image detecting unit that detects a signal having passed the first trap unit or the detour unit; a video equalizer unit 40 that compensates a frequency characteristic within the predetermined signal band; a second switch unit that switches an operation of the video equalizer unit; and a selection control unit 21 that controls switching operations of the first switch unit 13 and the second switch unit.

### BACKGROUND OF THE INVENTION

1. Field of the Invention

The present invention relates to a television tuner, and more specifically, to a television tuner capable of improving a frequency characteristic of a receiver signal after a FM trap.

2. Description of the Related Art

In the US TV broadcast, a frequency band allocated for channel 6 (hereinafter, referred to as ‘US 6ch’) is from 82 to 88 MHz, and a sound carrier frequency thereof is fixed at 87.75 MHz. Alternatively, in the US FM radio broadcast, the frequency band is extended from 88 to 108 MHz, and the broadcast of a frequency approximated to the frequency band of channel 6 in TV broadcast is existed. That is, 88 MHz is a frequency (hereinafter, referred to as ‘boundary frequency’) partitioning an upper end of the channel 6 (US 6ch) of the US TV broadcast and a lower end of the US FM radio broadcast.

Therefore, when a receiver electric field intensity is comparatively large, beat noise is represented in an image as noise is generated in a regenerated sound at the time of receiving the TV broadcast of US 6ch.

In a typical television tuner for receiving the United States TV broadcast, FM trap circuit of approximately 91 to 93 MHz band is connected to a receiver signal input terminal, and a receiver signal adjacent to the aforementioned boundary frequency which is the lower end of the United States FM radio broadcast is made to be attenuated by the trap circuit thereof.

In such television tuners, it is ideal to attenuate only the band of FM radio broadcast when trying to select to receive the TV broadcast of US 6ch by the FM trap circuit functioning.

However, it is difficult to attenuate only the FM radio broadcast without giving any effect on the US 6ch band, and problem arises in a conventional television tuner that a video signal (particularly, chroma signal component) of high-pass end near to the aforementioned boundary frequency (88 MHz) among the aforementioned US 6ch occupies a band frequencies extending from 82 to 88 MHz is particularly affected by the aforementioned FM trap circuit and is attenuated, and thus a picture quality of television is degraded.

In other words, it is ideal for the aforementioned FM trap circuit to attenuate only the signal within a predetermined frequency band (FM radio broadcast band) in which the boundary frequency (88 MHz of which is the United States FM radio broadcast) is the lower limit, however in reality, band of the US 6ch which is below the boundary frequency is taken over and is attenuated together, and problem arises in that a part loss of frequency characteristic (characteristic f) of the video signal is thus generated.

### SUMMARY OF THE INVENTION

The present invention is to solve the aforementioned conventional problems and the object is to provide an improved frequency characteristic of the receiver signal (video signal) after an FM trap, and a television tuner to give a highly modified picture quality.

The present invention comprises a detour unit that allows a receiver signal to pass directly, a first trap unit that attenuates a predetermined signal band included in the receiver signal, a first switch unit that switches a signal pathway in which the receiver signal passes to any of the first trap unit or the detour unit, an image detecting unit that detects a signal having passed the first trap unit or the detour unit so as to generate an image base band signal comes from a predetermined signal band, a video equalizer unit that compensates a frequency characteristic within the predetermined signal band, a second switch unit that switches an operation of the video equalizer unit, and a selection control unit that controls switching operations of the first switch unit and the second switch unit.

In the present invention, when receiving predetermined television channels (e.g., US 6ch), the video equalizer unit can compensate a portion attenuated by the first trap unit, and when receiving channels other than the predetermined television channels, generation of attenuation can be prevented by being passed through the detour unit. Therefore, since all signals included within a band (band width) of the predetermined television channels are assuredly received, degradation of the picture quality is particularly prevented.

Accordingly, the video equalizer unit comprises a circuit consisting of an inductance element and a capacitor element, a first resistor, and a second resistor having a smaller resistance value than the first resistor, and it is preferable to connect any one of the first resistor and the second resistor in parallel to the inductance element by the switching operation of the second switch unit.

In the above manner, when the first resistor is selected as an element connected to the inductance element in parallel, frequency characteristic of the video equalizer unit can be a raised characteristic of high-pass, and when the second resistor is selected, frequency characteristic of the video equalizer unit can be a frequency characteristic of high-pass less in raise compare to a case selected the first resistor.

Accordingly, when predetermined television channels are selected, the selection control unit controls a first switch unit to select a pathway of which passes through the first trap unit, and a second switch unit to output a selection signal for selecting the first resistor.

Alternatively, when channels other than predetermined television channels are selected, the selection control unit controls a first switch unit to select the detour unit and a second switch unit to output a selection signal for selecting the second resistor.

In the above manner, circuits appropriate in situations of when US 6ch are selected and any other channels are selected can be formed respectively.

For example, the first trap unit is preferable to attenuate a signal within a predetermined frequency band in which a lower limit is 88 MHz, and further a signal band of the predetermined television channel is preferable to be within the range of 82 MHz to 88 MHz.

In the above manner, the 6 channel of TV broadcast in the United States can be received assuredly. The selection control unit generates a selection signal in response to a channel switching signal.

In the above manner, operations of the first switch unit and the second switch unit are coincided. Therefore, circuits appropriate in situations when US 6ch is selected and any other channels are selected can be correctly selected.

Additionally, the present invention comprises a FM trap unit that attenuates a frequency signal of FM broadcast band, an image detecting unit that is connected to a rear end of the FM trap unit and outputs an image base band signal, and a video equalizer unit that is connected to the image detecting unit, wherein the FM trap unit is configured to turn ON when predetermined television channels are received and turn OFF when predetermined television channels are not received, and the video equalizer unit consists of a circuit by an inductance element and a capacitor element, and two resistors connected to the inductance element, and when the predetermined television channel is received, it selects the one resistor and when the predetermined television channel is not received, it selects the other resistor that comes from a smaller resistance value than the first resistor.

Accordingly, it is preferable that the input terminal of a switching circuit having a first output terminal, a second output terminal and an input terminal alternatively conducted between the first output terminal or between the second output terminal is connected to one end at the side of the image detecting circuit of the inductance element, one end of the first resistor is connected to the first output terminal, one end of the second resistor is connected to the second output terminal, the other ends of the first resistor and the second resistor are connected to each other, the connection points thereof are connected to the other end of the inductance element, a resistance value of the first resistor is set to be larger than that of the second resistor, and that when the FM trap circuit is turned ON, at the same time the switching circuit at the side of the first resistor is switched. In the above way, switching operation of the video equalizer unit can be performed assuredly.

Television tuner of the present invention can flatten a frequency characteristic for a predetermined television channel such as channel 6 fixed within a band of lower end of the FM radio broadcast in the United States. Thus, the signal within the all ranges of low-pass to high-pass band width which forms such predetermined television channels can be received assuredly.

### BRIEF DESCRIPTION OF THE DRAWINGS

FIG. 1 is a block diagram showing the overall configuration of a television tuner according to the present invention.

FIG. 2 is a block diagram showing the configuration of an IF unit.

FIG. 3 is a circuit diagram showing a video equalizer as a major unit according to the present invention.

FIG. 4 is a schematic diagram showing a base band frequency characteristic of the IF unit in the case of assuming that the video equalizer unit is not connected.

FIG. 5 is a schematic diagram showing the base band frequency characteristic of the video equalizer unit.

FIG. 6 is a schematic diagram showing an overall frequency characteristic of the television tuner according to the present invention.

### DESCRIPTION OF THE PREFERRED EMBODIMENT

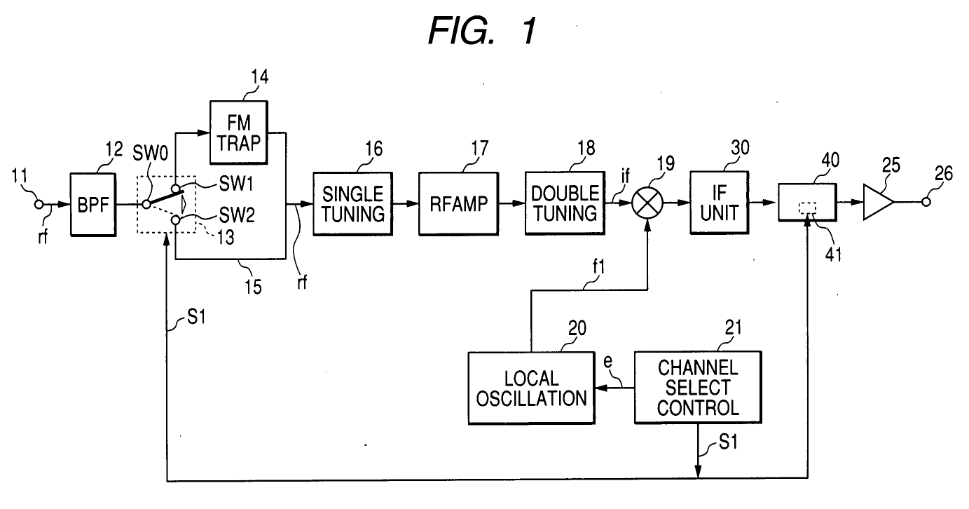

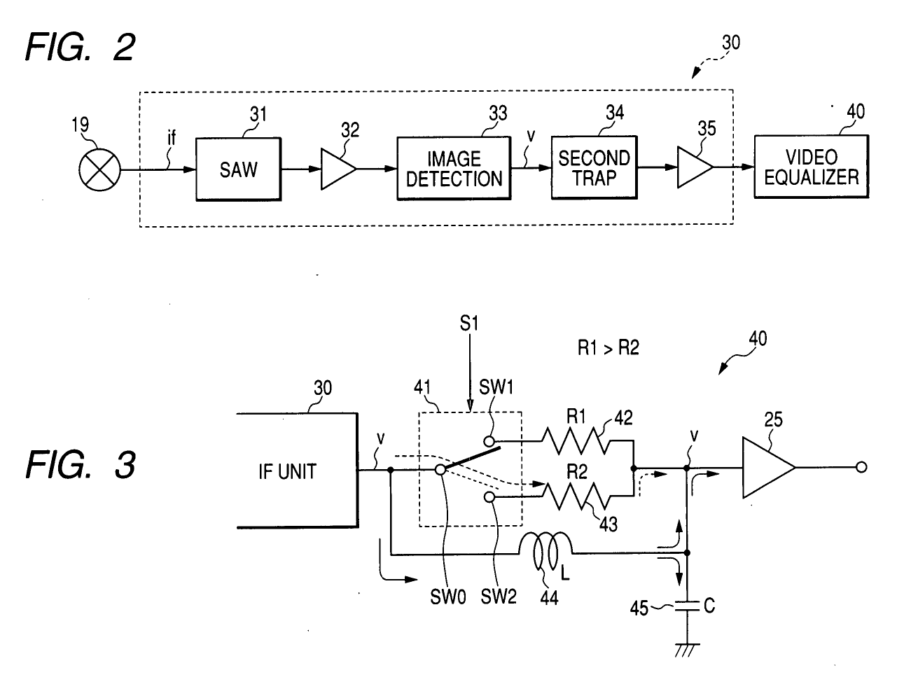

FIG. 1 is a block diagram showing the overall configuration of a television tuner according to the present invention, FIG. 2 is a block diagram showing the configuration of an IF unit, FIG. 3 is a circuit diagram showing a video equalizer unit as a major unit according to the present invention.

According to the present invention, when two frequency bands are adjacent to each other such as the predetermined television channels (e.g., channel 6 of the TV broadcast in the United States (US 6ch: 82 MHz to 88 MHz)) and the broadcast band fixed to the upper end thereof for example FM radio broadcast (88 MHz to 108 MHz), and when desired receiver signals are picked up from other signal bands (predetermined television channels) in an attenuated state by a trap (FM trap) at a lower end of one broadcast band and adjacent to a boundary frequency (88 MHz), effect of the trap is beyond the receiver signal detected from the aforementioned signal bands of others, and particularly a frequency characteristic of upper end (high-pass) near to the boundary frequency of the aforementioned signal bands of others is flattened.

According to the FIG. 1, the television tuner of the present invention consists of a signal input unit 11, a band pass filter unit (BPF) 12, a first switch unit 13, a FM trap unit 14 (first trap), a detour unit 15, a single tuning unit 16, a radio-frequency amplifying unit (RFAMP) 17, a double tuning unit 18, a mixing unit (MIX) 19, a local oscillating unit 20, a channel selection control unit 21, an IF unit 30, a video equalizer unit 40, a buffer unit 25, and a signal output unit 26.

The IF unit 30 consists of a SAW filter 31, an intermediate frequency amplifying unit 32, an image detecting unit 33, a second trap unit 34 and an image amplifying unit 35 as shown in FIG. 2.

The video equalizer unit 40 is constructed as shown in FIG. 3 by consisting of a second switch unit 41, a first resistor 42 formed with resistance R1, a second resistor 43 formed with resistance R2, an inductance element 44 formed with an inductance L, and a capacitor element 45 formed with a capacity C. Basic configuration of the video equalizer unit 40 is circuits formed by the inductance element 44 and the capacitor 45, and both ends of the inductance element 44 alternatively selects any one of the first resistor 42 and the second resistor 43.

The channel selection control unit 21 shown in FIG. 1 receives a channel switching signal given by a remote control apparatus or the like, and channel voltage e responding therefor is given to the local oscillating unit 20. The local oscillating unit 20 that received the channel voltage e, functions to fit the local oscillation signal into a predetermined frequency (local oscillation frequency) which corresponds to a tuned channel by a use of PLL circuit (not shown) employed in an inner part. The, the local oscillation frequency signal f1 which is fitted in the manner thereof is given to the mixing unit 19.

In addition, the selection control unit 21 functions for example to generate a selection signal S1 of 0 v when US 6ch is selected, and a selection signal S1 of 5 v when other than US 6ch is selected, so as to be outputted to the first switch unit 13 and to the second switch unit 41 respectively.

As shown in FIG. 3, the first resistor 42 and the second resistor 43 constructing the video equalizer unit 40 are equipped in a state connectable to a signal pathway of which is the main. The second switch unit 41 is equipped in between an output terminal of the IF unit 30 and each input terminal of the first resistor 42 and the second resistor 43, and this second switch unit 41 selects any of the first resistor 42 or the second resistor 43 in response to the selection signal S1 which comes from the selection control unit 21, so as to be freely switched.

The inductance element 44 is connected in parallel to the first resistor 42 and the second resistor 43. The terminals at the output side of the first resistor 42, the second resistor 43 and the inductance element 44, are input to the buffer unit 25 and connected to the ground via a capacitor element 45.

The video equalizer unit 40 employs peaking circuits of high-pass, particularly near to a color subcarrier frequency (3.58 MHz) by the inductance element 44, the capacitor element 45, and the resistor 42 or the resistor 43, and a peaking amount is adjusted by resistance of the first resistor 42 or the second resistor 43. That is, when the resistance is large, the peaking amount becomes large and at the same time becomes to a raised frequency characteristic of high-pass, particularly nearby a color subcarrier frequency (3.58 MHz), and alternatively when the resistance is small, the peaking amount becomes small, and becomes to a frequency characteristic of high-pass less in raise.

Relationship between the first resistor 42 and the second resistor 43 is set for a resistance R1 of the first resistor 42 to be a larger resistance than a resistance R2 of the second resistor 43 (R1>R2). Configuration of the video equalizer 40 to be described later is not limited to the configuration shown in diagram 3 above.

Hereinafter, operation of the television tuner of the present invention will be described.

As shown in FIG. 1, a receiver signal rf which comes from a TV broadcast or FM radio broadcast or the like taken from an external antenna is given to the signal input unit 11. The receiver signal rf given to the signal input unit 11 is inputted to the band pass filter 12. This band pass filter 12 is functioned to remove unwanted signals existing outside broadcasts band, the TV broadcast or FM broadcast, in approximate range, and to pass the wanted receiver signal (TV broadcast or FM radio broadcast) rf existing in the broadcasts band.

The receiver signal rf which has passed the band pass filter 12 is selected in the first switch unit 13, and one part is inputted to the single tuning unit 16 via the FM trap unit 14, and other part is directly inputted to the single tuning unit via the detour unit 15.

The first switch unit 13 can perform switching in response to the selection signals S1 of the 0 v or 5 v given by the channel selection control unit 21. For example, when the selection signal (at the time of receiving the US 6ch) S1 of 0 v is given, part between a terminal SW0 and a terminal SW2 of the first switch unit 13 is opened to connect terminal the SW0 and a terminal SW1 (first conduction state shown as a full line in FIG. 1), and when the selection signal (at the time of receiving other than the US 6ch) S of 5 v is given, part between the terminal SW0 and the terminal SW1 is opened to connect the terminal SW0 and the terminal SW2 (second conduction state shown as a dotted line in FIG. 1). Herein, as the first switch unit 13, examples of switching diode disclosed in Japanese Patent Application No. 1999-205699 can be included.

Since the detour unit 15 is cut off from a signal pathway when the first conduction state is selected (at the time of receiving the US 6ch), the receiver signal rf is inputted to the single tuning unit 16 via the FM trap unit 14. Alternatively, when the second conduction state is selected (at the time of receiving other than the US 6ch), the receiver signal rf does not pass the FM trap unit 14, and instead passes the detour unit 15 to be directly inputted to the single tuning unit 16.

The FM trap unit 14 is constructed as an attenuator to attenuate only the signals within a predetermined frequency band consisting of FM radio broadcast frequency adjacent to the US 6ch. Therefore, when the first conduction state is selected (at the time of receiving the US 6ch), a receiver signal rf of which the FM radio broadcast frequency component is attenuated is inputted to the single tuning unit 16, and when the second conduction state is selected (at the time of receiving other than the US 6ch), a receiver signal rf containing the FM radio broadcast frequency component is inputted to the single tuning unit 16.

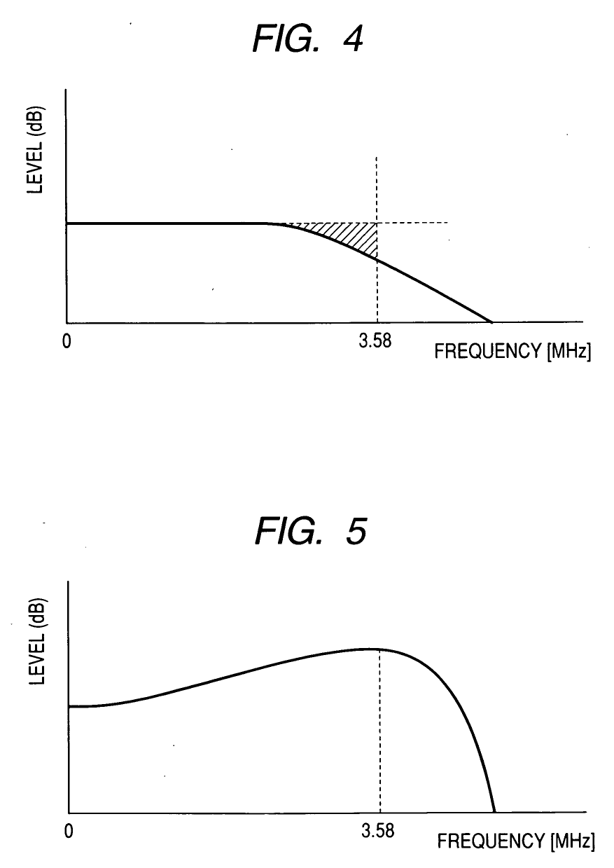

FIG. 4 is a schematic diagram showing a base band frequency characteristic of the IF unit in the case of assuming that the video equalizer unit is not connected.

Since the frequency characteristic of the FM trap unit 14 is made to be attenuated by a predetermined inclination (for example, −20 dB/dec) from just before the boundary frequency (88 MHz) which is the boundary of US ch6 and FM radio broadcast, according to the effect of the FM trap unit 14, as shown in FIG. 4, the base band frequency characteristic seen from an output terminal of the IF unit is in a state of circuit of high-pass, particularly near by a color subcarrier frequency (3.58 MHz), being attenuated (signal of a hatching part).

A receiver signal of desired channel is selected in the single tuning unit 16. Next, this receiver signal is amplified in the radio-frequency amplifying unit 17 and the desired receiver signal is further selected in the double tuning unit subsequently connected thereof, the selected receiver signal is mixed with the local oscillation frequency signal f1 outputted from the local oscillating unit 20 in the mixing unit 19 to be changed into an intermediate frequency signal if, and the intermediate frequency signal if is outputted to the IF unit 30. In the intermediate frequency signal if, an image intermediate frequency signal, a color subcarrier frequency signal, a sound intermediate frequency signal and the like are included.

As shown in FIG. 2, the intermediate frequency signal if inputted to the IF unit 30 is inputted to the intermediate frequency amplifying unit 32 via the SAW filter 31. The SAW filter 31 has a transmission characteristic to level an image intermediate frequency signal, a color subcarrier frequency signal, and a sound intermediate frequency signal if which are within an intermediate frequency band, into a predetermined level. The intermediate frequency signal if amplified to the predetermined level in the intermediate frequency amplifying unit 32 is detected by the image detecting unit 33 and is changed into a video signal (also known as an ‘image base band’).

The video signal v is inputted to the image amplifying unit 35 via the second trap unit 34, and then the video signal v amplified by the amplifying unit 35 is inputted to the video equalizer unit 40. Herein, the second trap unit 34 functions to stop a sound signal mixed to the video signal v or a signal level of other channel adjacent to the desired channel so as to suppress a bad impact such as an interference fringe causing to the desired channel by the signals thereof.

FIG. 5 is a schematic diagram showing the base band frequency characteristic of the video equalizer unit when US 6ch is selected.

When US 6ch is selected, part between the terminals of the second switch unit 41 SW0 and SW1 is connected by the selection signal S1 outputted from the channel selection control unit, thus the first resistor 42 from a large resistance R1 is connected in parallel to both terminals of the inductance element 44.

Hereat, the base band frequency characteristic of the video equalizer unit 40 is as shown in FIG. 5. Since a frequency characteristic at output terminal of the IF unit when assumed that the video equalizer unit is not connected, is that the high-pass unit of the base band signal, that is nearby a subcarrier frequency (3.58 MHz), is attenuated (referred to FIG. 4) by an impact of the FM trap unit 14, the frequency characteristic of the video equalizer unit has a characteristic of rise in the high-pass unit such as nearby the subcarrier frequency by raising a level corresponding to the part so as to compensate the attenuation.

The frequency characteristic of the video equalizer unit thus is a frequency characteristic of a high-pass raised by peaking circuits from the inductance element 44, the capacitor element 45 and the first resistor 42.

A peaking frequency of the video equalizer unit 40 can be set into a desirable frequency as shown in FIG. 5 by an applicable use of an inductance L of the inductance element 44 and a capacity C of the capacitor element 45.

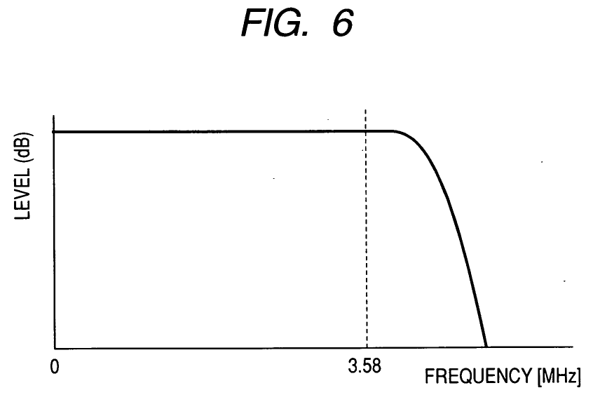

FIG. 6 is a schematic diagram showing an overall frequency characteristic of the television tuner of the present invention. As shown in FIG. 6, according to the television tuner of the present invention, the video equalizer unit 40 can compensate a part of receiver signal attenuated by the FM trap unit 14. In this manner, all of frequency characteristics of the video signal v including the FM trap unit 14 and the video equalizer unit 40 basically can be turned into flat frequency characteristics as shown in FIG. 6.

Therefore, an impact on the signal band of the US 6ch set in a lower end of the boundary frequency can be further minimized than in the past, and at the same time the FM radio broadcast allocated in an upper end of the boundary frequency can be more effectively attenuated. Thus, it becomes possible to improve a picture quality when receiving the US 6ch.

Meanwhile, when channels other than the US 6ch are selected, part between the terminal SW0 and the terminal SW2 of the second switch unit 41 is connected as shown as a dotted line in FIG. 3, by a selection signal S1 of the channel selection control unit 21. In this manner, the second resistor 43 from a resistance R2 which is smaller than the resistance R1 of first resistor is connected in parallel to both terminals of the inductance element 44.

The resistance R2 of the second resistor 43 is relatively small compared to the resistance R1 of the first resistor 42 (R1>R2). At the same time, amount of peaking of peaking circuits from the inductance element 44, the capacitor element 45 and the second resistor 43 in the video equalizer unit therefor becomes relatively small compared to a situation when the first resistor 42 is connected.

That is, if the second resistor 43 with a small resistance is connected to both ends of the inductance element 44, the video signal v outputted from the IF unit 30 is raised in level by some extent in a high-pass unit that is nearby a subcarrier frequency (3.58 MHz) in the frequency characteristic thereof, in accordance with the peaking circuits of the video equalizer unit, and as a result, almost flattened characteristic as shown in FIG. 6 is outputted in the output terminal of the video equalizer unit.

In the aforementioned manner, it becomes possible to improve a picture quality of channels of the lower end band (US 6ch) by compensating a declining of low end band of the boundary frequency (US 6ch), particularly an attenuated high-pass, by making the second switch 41 to be switched by coupling a selection operation of the US 6ch.

In the aforementioned embodiment, configuration capable of switching the first resistor or the second resistor by the second switch unit 41 is shown, however the present invention is not limited this. For example, it can be a configuration equipping an adjustable resistor instead of the first resistor or the second resistor, and changing a resistance for the time of receiving a predetermined channel or for the time of receiving other channels accordingly.

Also in the aforementioned embodiment, configuration of the first switch unit 13 equipped in latter to the band pass filter 12 and former to the FM trap unit 14 and the detour unit 15 is shown, however the present invention is not limited to this, and it can also be in a configuration of equipped in latter to the FM trap unit 14 and the detour unit 15 and former to the single tuning unit 16.

Further, in the aforementioned embodiment, case of channel 6 in the United States and FM radio broadcast are explained as examples of a predetermined TV channel and a broadcast band, however the present invention is not limited to this and it can be subjected to other broadcast bands.

1. A television tuner comprising:
a detour unit that allows a receiver signal to directly pass;
a first trap unit that attenuates a predetermined signal band included in the receiver signal;
a first switch unit that switches a signal pathway in which the receiver signal passes to any of the first trap unit or the detour unit;
an image detecting unit that detects a signal having passed the first trap unit or the detour unit so as to generate an image base band signal coming from a predetermined signal band;
a video equalizer unit that compensates a frequency characteristic within the predetermined signal band;
a second switch unit that switches an operation of the video equalizer unit; and
a selection control unit that controls switching operations of the first switch unit and the second switch unit.

2. The television tuner according to claim 1, wherein the video equalizer unit comprises a circuit consisting of an inductance element and a capacitor element, a first resistor, and a second resistor having a smaller resistance value than the first resistor, and any one of the first resistor and the second resistor is connected in parallel to the inductance element by the switching operation of the second switch unit.

3. The television tuner according to claim 1, wherein, when predetermined television channels are selected, the selection control unit controls a first switch unit to select a pathway which passes through the first trap unit, and a second switch unit to output a selection signal which selects the first resistor.

4. The television tuner according to claim 1, wherein, when channels other than predetermined television channels are selected, the selection control unit controls a first switch unit to select the detour unit and a second switch unit to output a selection signal which selects the second resistor.

5. The television tuner according to claim 1, wherein the first trap unit attenuates a signal within a predetermined frequency band in which a lower limit is 88 MHz.

6. The television tuner according to claim 1, wherein a signal band of the predetermined television channel is within the range of 82 MHz to 88 MHz.

7. The television tuner according to claim 1, wherein the selection control unit generates a selection signal in response to a channel switching signal.

8. A television tuner comprising:
A FM trap unit that attenuates a frequency signal of FM broadcast band;
An image detecting unit that is connected to a rear end of the FM trap unit and outputs an image base band signal; and
a video equalizer unit that is connected to the image detecting unit,
wherein the FM trap unit is configured to turn ON when a predetermined television channel is received and turn OFF when a predetermined television channel is not received, and
wherein the video equalizer unit consists of a circuit by an inductance element and a capacitor element and two resistors connected between both ends of the inductance element, and when the predetermined television channel is received, selects the one resistor and when the predetermined television channel is not received, selects the other resistor that comes from a smaller resistance value than the first resistor.

9. The television tuner according to claim 8, wherein an input terminal of a switching circuit having a first output terminal, a second output terminal and an input terminal selectively conducted between the first output terminal or between the second output terminal is connected to one end at the side of the image detecting circuit of the inductance element, one end of the first resistor is connected to the first output terminal, one end of the second resistor is connected to the second output terminal, the other ends of the first resistor and the second resistor are connected to each other, the connection points thereof are connected to the other end of the inductance element, a resistance of the first resistor is set to be larger than that of the second resistor, and when the FM trap circuit is turned ON, at the same time the switching circuit at the side of the first resistor is made to be switched.
